(19) United States
(12) Patent Application Publication
(10) Pub. No.: US 2010/0180832 A1
(43) Pub. Date: Jul. 22, 2010

(54) PLUSH PET TOY AND METHOD OF CONSTRUCTING THEREOF

(75) Inventor: Julie KRAUSS, Totowa, NJ (US)

Correspondence Address: OSTROLENK FABER GERB & SOFFEN, 1180 AVENUE OF THE AMERICAS, NEW YORK, NY, 100368403, US

(73) Assignee: ALLURE PET PRODUCTS LLC, Totowa, NJ (US)

(21) Appl. No.: 12/686,133

(22) Filed: Jan. 12, 2010

Related U.S. Application Data
(60) Provisional application No. 61/143,873, filed on Jan. 12, 2009.

(51) Int. Cl. A01K 15/02; D05B 23/00

(52) U.S. Cl. 119/707; 112/475.08

(57) ABSTRACT

A durable pet toy and a method of constructing thereof, where the toy is constructed by first forming pieces of three-layered material by bonding together an inside layer, a middle layer and an outside layer. The pieces of the three-layered material are then sewn together with a seam and a binding is applied to stress points of the pet toy.

### CROSS REFERENCE TO RELATED APPLICATION(S)

The present application claims priority of U.S. Provisional Application Ser. No. 61/143,873, filed Jan. 12, 2009, by Julie Krauss entitled PLUSH TOY AND METHOD OF CONSTRUCTING THEREOF, the disclosure of which has been incorporated by reference.

### FIELD OF THE INVENTION

The invention generally relates to the field of pet toys.

### BACKGROUND OF THE INVENTION

For pets, especially dogs, to be happy and healthy, they need to stay active. Pet toys play a major part in keeping them active, as well as in pet training. This is especially true for young puppies during their teething and training process. Dogs seem to enjoy chewing on and carrying around soft, plush toys. Not only are they easy for them to grasp, they are soft and lightweight. However, dogs are powerful chewers. Dog owners become frustrated when, after spending $5.00 to $25.00 on a soft, plush toy, their dog destroys this toy in a matter of minutes.

In an effort to keep pet owners satisfied and aggressive dogs happy, pet toy manufacturers have introduced a wide variety of toys made from heavy materials like vinyl, latex, polyurethane and rubber. However many dogs can easily chew these toys as well. Further, many dogs do not like heavy rubber toys which typically lack interesting parts to chew and play with. There have been attempts to make more durable soft toys. However, each has significant drawbacks. In some instances, the toys are too heavy and/or have outside seams that dogs find and destroy. In other instances, an additional layer of lining has been added to the body of the toy but their seams and stitching is still vulnerable.

### SUMMARY OF THE INVENTION

To eliminate the drawbacks of the prior art, it is a general object of the present invention to provide a three step manufacturing process which provides a solution for dog owners who have aggressive chewers yet still want to purchase soft, lightweight plush toys.

Accordingly, in one general aspect, the invention is a method of constructing a durable pet toy, where the toy is constructed by first forming pieces of three-layered material by bonding together an inside layer, a middle layer and an outside layer. The pieces of the three-layered material are then sewn together with a seam and a binding is applied to stress points of the pet toy.

In another general aspect, the invention is a pet toy having multiple pieces formed from a toy material in which an inside layer, a middle layer and an outside layer are bonded together. The pieces of the toy material are joined together with a seam, and a binding is applied to stress points of the pet toy.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is a perspective cut-out view of the inside-out pet toy in accordance with the preferred embodiment of the present invention.

FIG. 2 is a front view of one of the seams of the pet toy.

FIG. 3 is a perspective view of the inside-out pet toy in accordance with the preferred embodiment of the present invention.

FIG. 4 is a schematic illustration of the steps performed in accordance with the preferred method of the present invention.

### DETAILED DESCRIPTION OF THE PREFERRED EMBODIMENT AND THE DRAWINGS

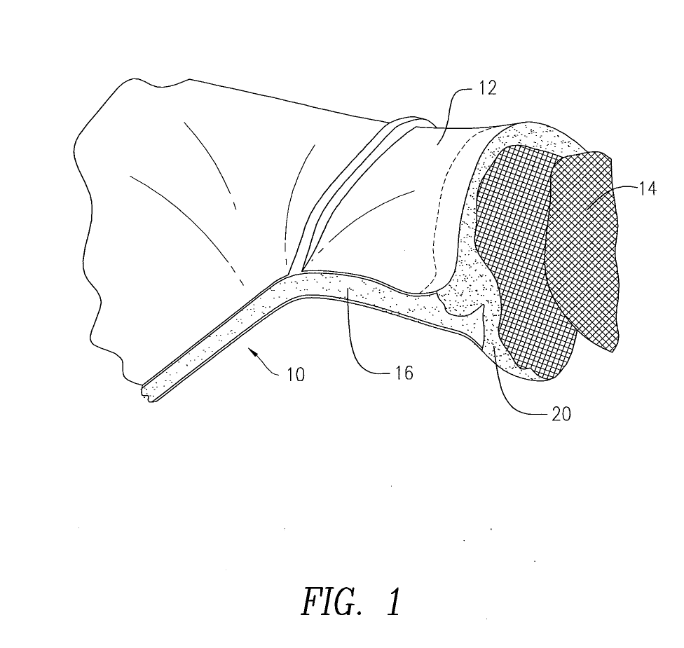

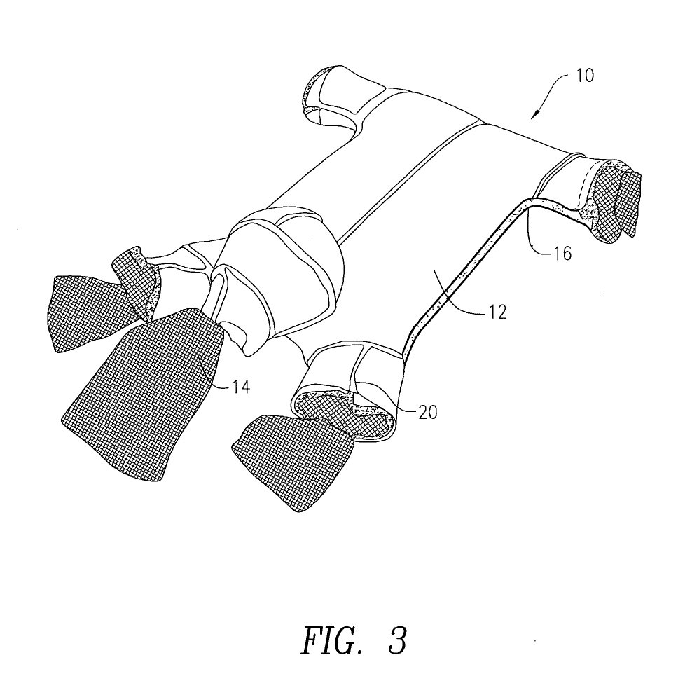

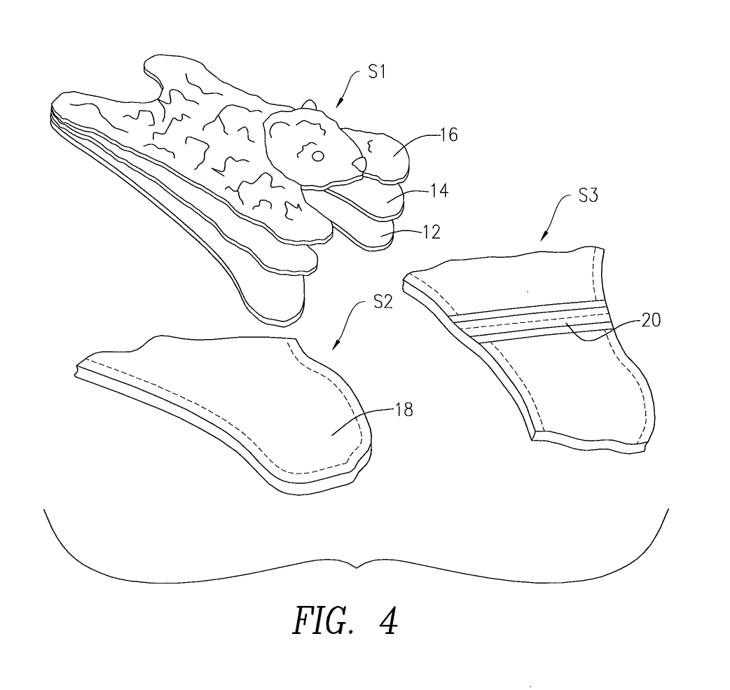

As shown in FIGS. 1 and 2-3, in its preferred embodiment, a pet toy 10 includes at least three layers: an inside layer 12, a middle layer 14 and an outside layer 16. The inside layer is preferably made of heavy-duty dense fiber material, for example, 210 denier polyester. Middle layer 14 is preferably a rugged, tear resistant sport mesh, for example, white polyester sneaker mesh. Any other suitable color of polyester mesh may be utilized. Finally, the outside layer 16 is preferably a custom designed plush or fleece fabric to provide an appropriate look and feel of the toy. The outside layer may also include a decorative or playful element to make the toy more attractive to animals. The three layers are preferably bonded together to form a durable material for the toy 10. Thus, as illustrated in FIG. 4, the first step S1 of the method for constructing the pet toy 10 is to bond the three layers discussed above to form the durable material for the toy. Pieces of the three-layered material may then be cut out in accordance with the toy's specification.

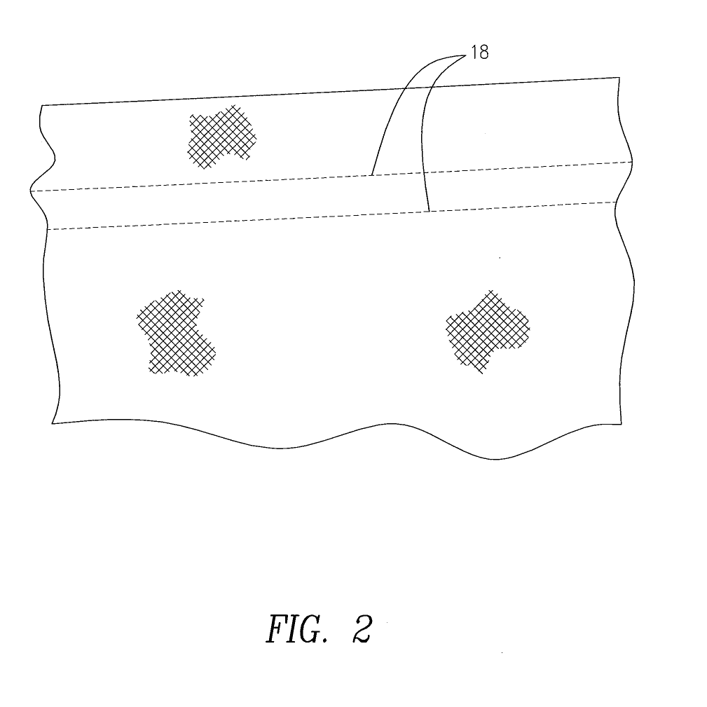

As shown in FIGS. 2 and 4, the cut out pieces of the three-layered material are next joined together in step S2 with a seam 18 having 8 to 10 stitches per inch or even a greater number of stitches per inch. That is 65% more stitches per inch than an industry standard. Preferably, a 202 nylon thread is utilized for the seam 18. Because seams 18 are formed on the inside of the toy, there are no external seams that can be easily opened by aggressive chewers.

Finally, a cotton binding 20 is sewn over all stress points in step S3 for extra strength of the toy. Materials other than cotton may be utilized for the binding.

As a result of the disclosed three-step process, the constructed pet toy is lightweight, yet strong and durable enough to withstand long-term scratching, biting, tugging and pulling by pets. In fact, the toy has been tested to withstand over 100 pounds of animal tugging and pulling.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

What is claimed is:

1. A pet toy comprising:
a plurality of pieces formed from a toy material including
an inside layer,
a middle layer, and
an outside layer, the inside layer, the middle layer and the outside layer being bonded together,
the pieces of the toy material being joined together with a seam; and
a binding applied to stress points of the pet toy.

2. The pet toy according to claim 1, wherein the inside layer comprises a 210-denier polyester.

3. The pet toy according to claim 1, wherein the middle layer comprises a polyester sneaker mesh.

4. The pet toy according to claim 1, wherein the seam includes more than 8 stitches per inch.

5. The pet toy according to claim 4, wherein the seam is formed inside of the toy.

6. The pet toy according to claim 1, wherein the toy is made of materials and the materials are held together to withstand at least a force of 100 pounds of animal tugging and pulling.

7. The pet toy according to claim 1, wherein the seam comprises a 202 nylon thread.

8. The pet toy according to claim 1, wherein the binding is made of cotton.

9. A method of constructing a pet toy, the method comprising the steps of:
forming pieces of three-layered material by bonding together an inside layer, a middle layer and an outside layer;
attaching the formed pieces of three-layered material by sewing them together with a seam; and
applying a binding to stress points of the pet toy.

10. The method according to claim 9, wherein the inside layer comprises a 210-denier polyester.

11. The method according to claim 9, wherein the middle layer comprises a polyester sneaker mesh.

12. The method according to claim 9, wherein the seam includes at least 8 to 10 stitches per inch.

13. The method according to claim 9, wherein the seam comprises a 202 nylon thread.

14. The method according to claim 9, wherein the binding is made of cotton.
